(19) United States
(12) Patent Application Publication
(10) Pub. No.: US 2017/0127121 A1
(43) Pub. Date: May 4, 2017

(54) DVR LIVE PAUSE AND RECORDING IN REFERENCED CHUNKS

(71) Applicant: Microsoft Technology Licensing, LLC, Redmond, WA (US)

(72) Inventors: Kevin Lingley, Saffron Walden (GB); Michal Mark Vine, Fleet (GB); David Coghlan, London (GB); Stewart Tootill, Bracknell (GB); Linden Vongsathorn, Godalming (GB)

(21) Appl. No.: 14/930,349

(22) Filed: Nov. 2, 2015

(51) Int. Cl. H04N 21/433; H04N 21/44; H04N 21/462; H04N 21/435; H04N 21/472; H04N 21/475; H04N 21/4147; H04N 21/4335

(52) U.S. Cl. CPC H04N 21/4333; H04N 21/4147; H04N 21/44004; H04N 21/4335; H04N 21/435; H04N 21/47217; H04N 21/475; H04N 21/4622

(57) ABSTRACT

A system and method are disclosed for viewing and recording television content received within a DVR or the like. The system stores the content in discrete data chunks, and assigns each chunk a first reference count. When a user wishes to record incoming received content, the reference count of the chunks associated with the content to be recorded are updated from the first reference count to a second reference count. In this way, the data chunks may be shared by the different systems (e.g., the moving live pause buffer and one or more recorded DVR streams) and it is not necessary to create and save multiple copies of the received content. Older data chunks of the first reference count may be periodically purged as new data chunks are created.

### BACKGROUND

Traditional digital video recorders (DVRs) and the like allow live pause and recording of received content. Live pause refers to a DVR function that pauses the picture on screen, while continuing to buffer the received content as it comes into the DVR. Live pause also allows users to rewind to earlier buffered content, and subsequently to fast forward to the current frame being buffered. Traditional DVRs also allow users to record content, albeit in a cumbersome manner. Specifically, when a user records content being buffered, the system determines the start and end time for the recorded content, and the recorded content is saved to a new file which is separate from a file containing the buffered content.

### SUMMARY

A system is provided for viewing and recording received content. As received content comes into a DVR or the like, it is stored in discrete chunks of data. In one example, a data chunk may be one minute's worth of received content data. Each chunk of buffered data may be assigned a unique identifier, such as a GUID, and a reference count, such as for example ‘1’. Thereafter, where a user wishes to record received content from the moving live pause buffer, instead of opening a new file for the content data to be saved, the chunks associated with the content to be recorded are identified, and their reference counts are changed, for example from a ‘1’ to a ‘2’.

When the DVR buffer is full, or after some predetermined amount of buffering of the received content, older data chunks may be purged. Specifically, where a data chunk has a reference count of ‘1’ (i.e., buffered but not recorded), it may be purged. Conversely, where a data chunk has a reference count of ‘2’ (i.e., buffered and recorded), it may be saved. In this manner, multiple systems (the moving live pause buffer and one or more recorded DVR streams) have access to a single copy of the data chunks, and there is no need to duplicate the data between the respective systems.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a topology for implementing embodiments of the present technology.

FIG. 2 is a system for implementing embodiments of the present technology.

FIGS. 3A and 3B together comprise a flowchart for the operation of embodiments of the present technology.

FIGS. 4A-4D illustrate data chunks and references associated with received content according to embodiments of the present technology.

FIGS. 5A-5D illustrate data chunks and references associated with received content according to further embodiments of the present technology.

FIG. 6A illustrates data chunks and references associated with received content according to further embodiments of the present technology.

FIG. 6B is an example of a manifest of the data chunks and references associated with the received content shown in FIG. 6A.

FIG. 7 is a flowchart for the operation of embodiments of the present technology upon start-up of a DVR implementing the present technology.

FIG. 8 is a block diagram depicting the components of an example entertainment console.

### DETAILED DESCRIPTION

A system and method are disclosed for viewing and recording television content transmitted or otherwise received within a DVR or the like. The system stores the content in discrete data chunks, and assigns each chunk an identifier and a first reference count. When a user wishes to record incoming received content, the reference count of the chunks associated with the content to be recorded are updated to a second reference count. In this way, the data chunks may be shared by the different systems (the moving live pause buffer and one or more recorded DVR streams) and it is not necessary to create and save multiple copies of the received content. Older data chunks of the first reference count may be periodically purged as new data chunks are created.

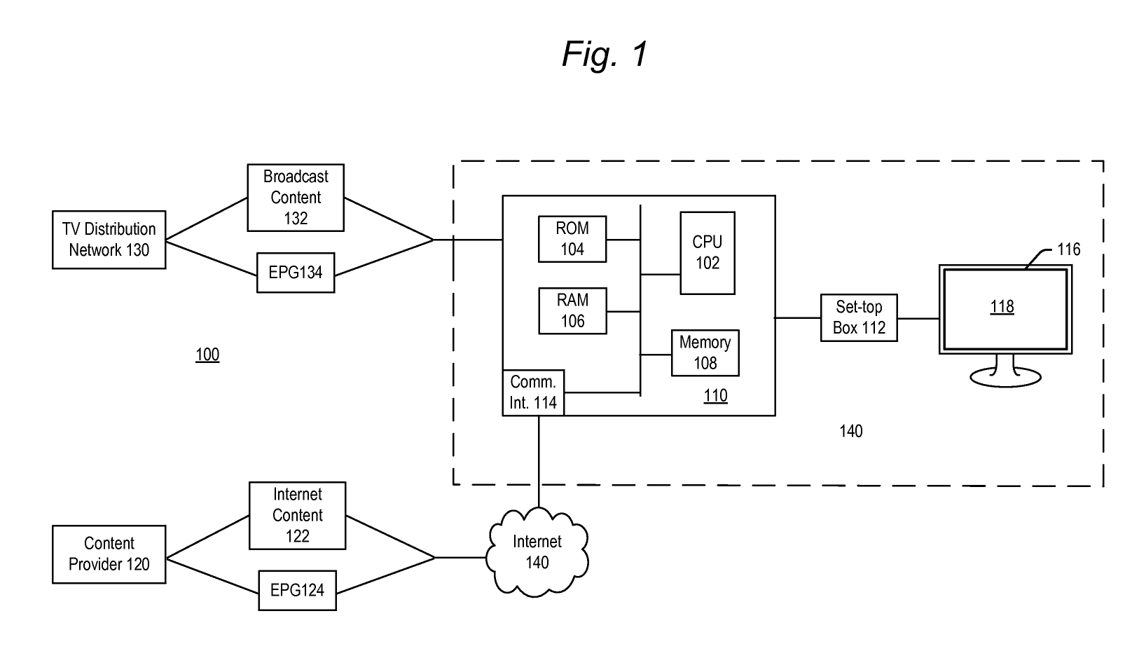

Referring initially to FIG. 1, there is shown a schematic block diagram of a topology 100 for implementing embodiments of the present technology. Topology 100 includes infrastructure for presenting received content to a user. The present technology may operate with any type of received content. For example, received content may be broadcast content 132 provided by a television distribution network 130, which may be for example a terrestrial television network (ABC, CBS, NBC, etc.), a cable TV provider, a satellite TV provider or other television distribution network. Alternatively, received content may be internet content 122 such as IPTV received from a content provider 120 via a network 138 such as the Internet.

One or both of the broadcast content 132 and the Internet content 122 may be transmitted with an electronic program guide (EPG) 134, 124. The EPGs 124, 134 may include a breakdown of received content by channel and by time. As explained hereinafter, the EPG data may be used in determining which data chunks to include upon a request to record received content.

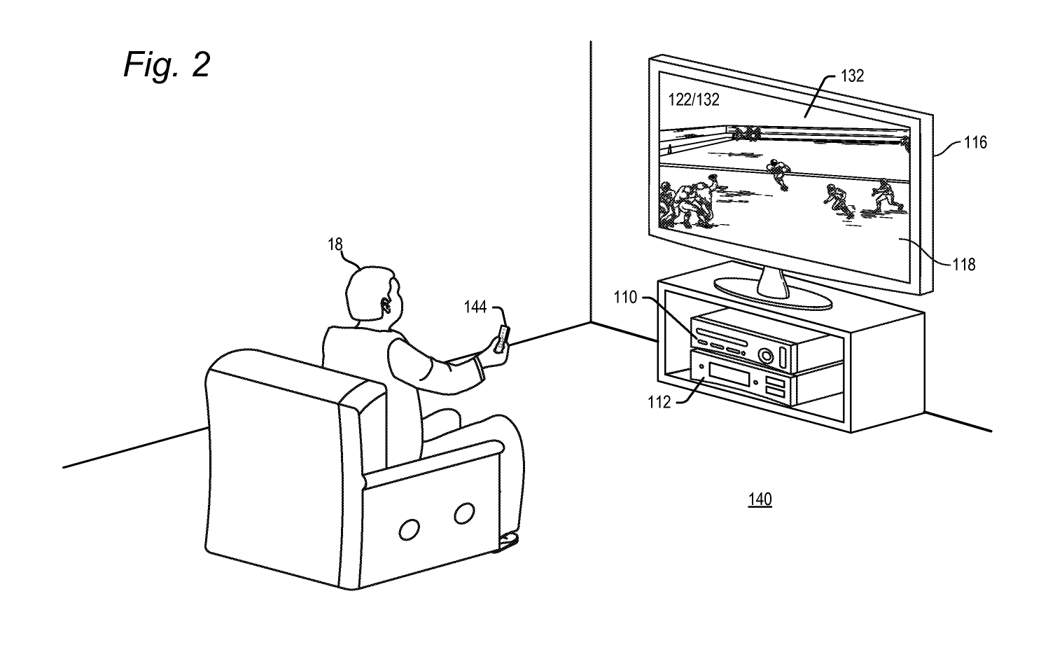

The content 122 and/or 132 and data from EPG 124 and/or 134 may be received within a computing device 110 for presentation on a display 118 of a television or other A/V device 116. The computing device 110 and A/V device 116 may be collocated within a location 140 such as for example a home, office, etc. (indicated by the dashed line in FIG. 1). FIG. 2 illustrates a location 140 with a user 18 watching received content 122/132 (an American football game in this example) on an A/V device 116 provided by the computing device 110. The A/V device 116 may for example be a monitor, a high-definition television (HDTV), or the like that may provide a video feed, game or application visuals and/or audio to the user 18. In embodiments, HDMI connections may be used between the computing device 110 and the A/V device 116, though other connections are contemplated.

FIG. 2 illustrates the user 18 operating a remote control 144 for interacting with the computing device 110. In a further embodiment, the computing device 110 may implement a natural user interface (NUI) system together with a depth camera (not shown) allowing the user 18 to interact with the computing device 110 through gestures and speech.

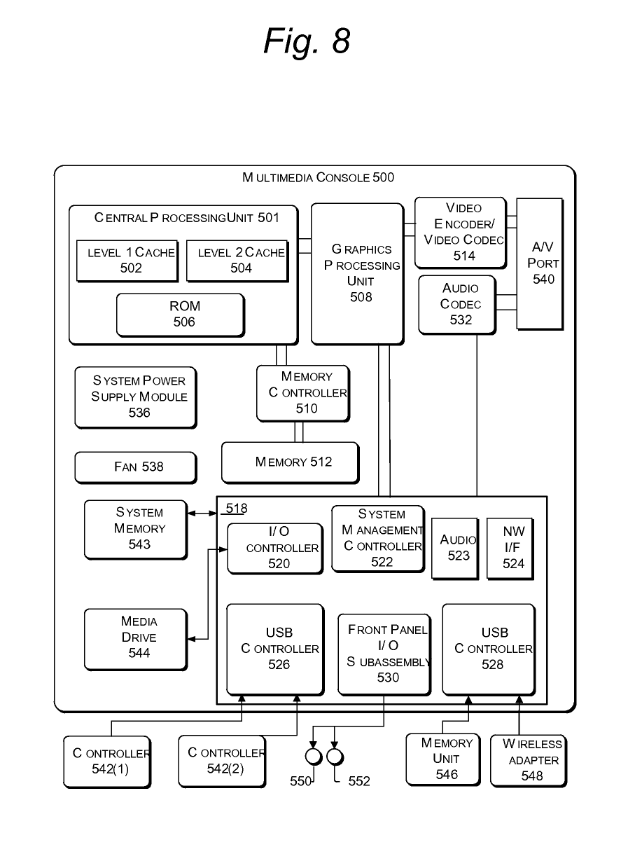

Details of an implementation of computing device 110 are provided below with respect to FIG. 8. However, in general, computing device 110 may be a DVR, desktop computer, media center PC, a gaming console and the like. As one example, computing device 110 may be the Xbox One® video game console from Microsoft Corp, Redmond, Calif. Computing device 110 may include a processor such as CPU 102 having access to read only memory (ROM) 104 and random access memory (RAM) 106. Device 110 may further include a non-volatile memory 108 for storing data and application programs, such as a data chunking application for implementing aspects of the present technology as explained below. A communications interface 114 may further be provided for networked communications, for example via the Internet. The computing device 110 may be or include a DVR for receiving, buffering and recording content.

As shown in FIGS. 1 and 2, a set-top box 112 may further be provided for selecting channels and converting a signal from the TV distribution network 130 and/or content provider 120 into a form for display on the A/V device 116. The set-top box 112 may be integrated into the computing device 110 in further embodiments, or vice-versa.

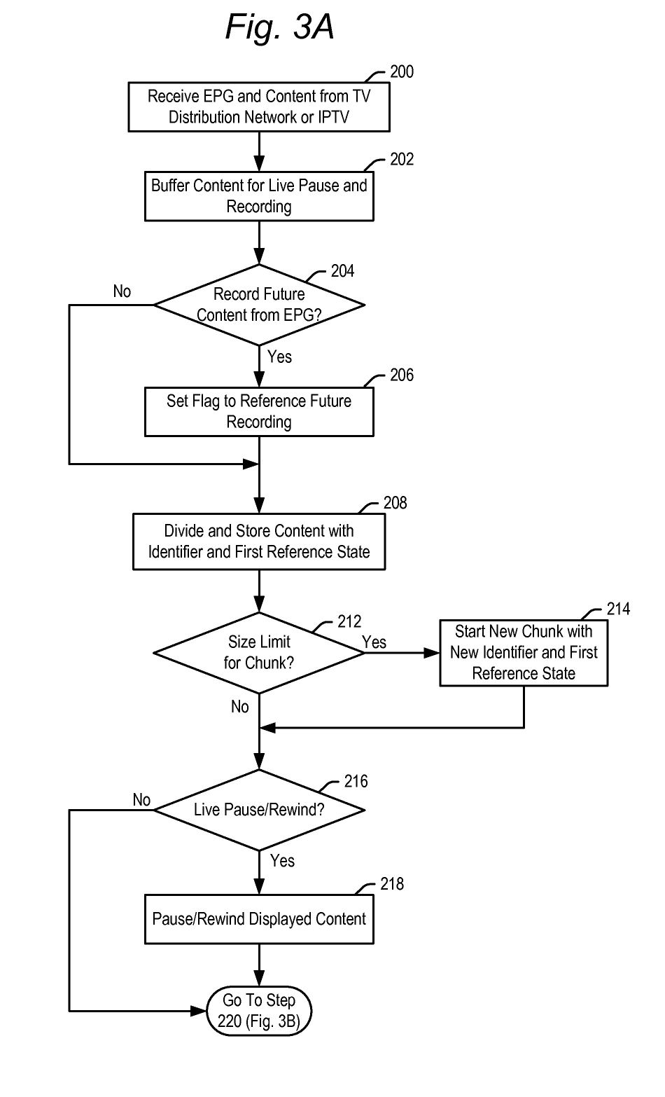

Operation of embodiments of the present technology will now be explained with reference to the flowchart of FIGS. 3A and 3B. In step 200, a stream of content and EPG data is received from the TV distribution network 130 or content provider 120 as explained above. In embodiments, the content is buffered in step 202 in memory 108, enabling live pause of the content and recording of the content as explained below. Live pause refers to the pausing or freezing of the image on the display, while the content continues to buffer. Live pause also refers to rewinding back through the content, and/or thereafter fast forwarding through the content to the present frame of received content, using remote control 144.

A user may peruse EPG data and set the computing device 110 to record content that is to be received in the future in step 204. If a future recording is selected in step 204, a flag is set in memory 108 in step 206 to designate the reference count of data chunks including the recorded content as explained below, once the data for the content is received.

Once the flag is set in step 206, or if no future recording is received in step 204, the content is stored in step 208. In accordance with aspects of the present technology, the received content is stored in chunks of discrete size. Each data chunk may be a set size, for example 30 Mb, 60 Mb or 120 Mb. Alternatively, each data chunk may be captured over a set length of time, for example, 30 seconds, 1 minute, 5 minutes or 10 minutes. It is understood that the size and/or length of time of each discrete data chunk may smaller, larger or otherwise different than the examples set forth above.

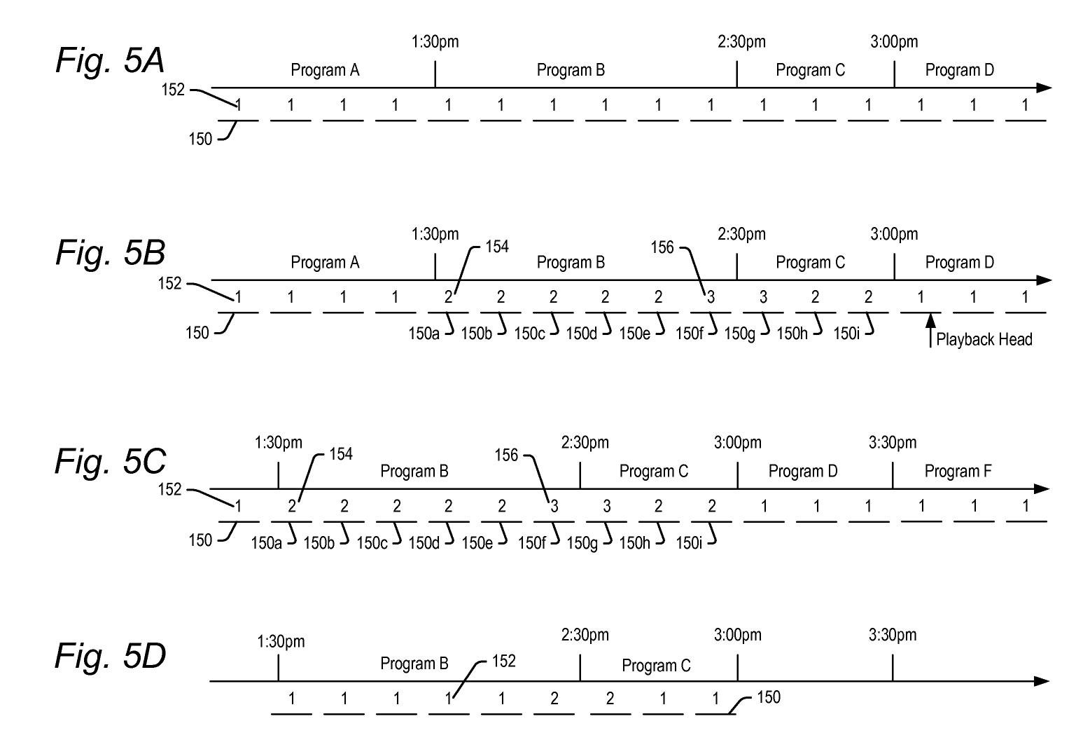

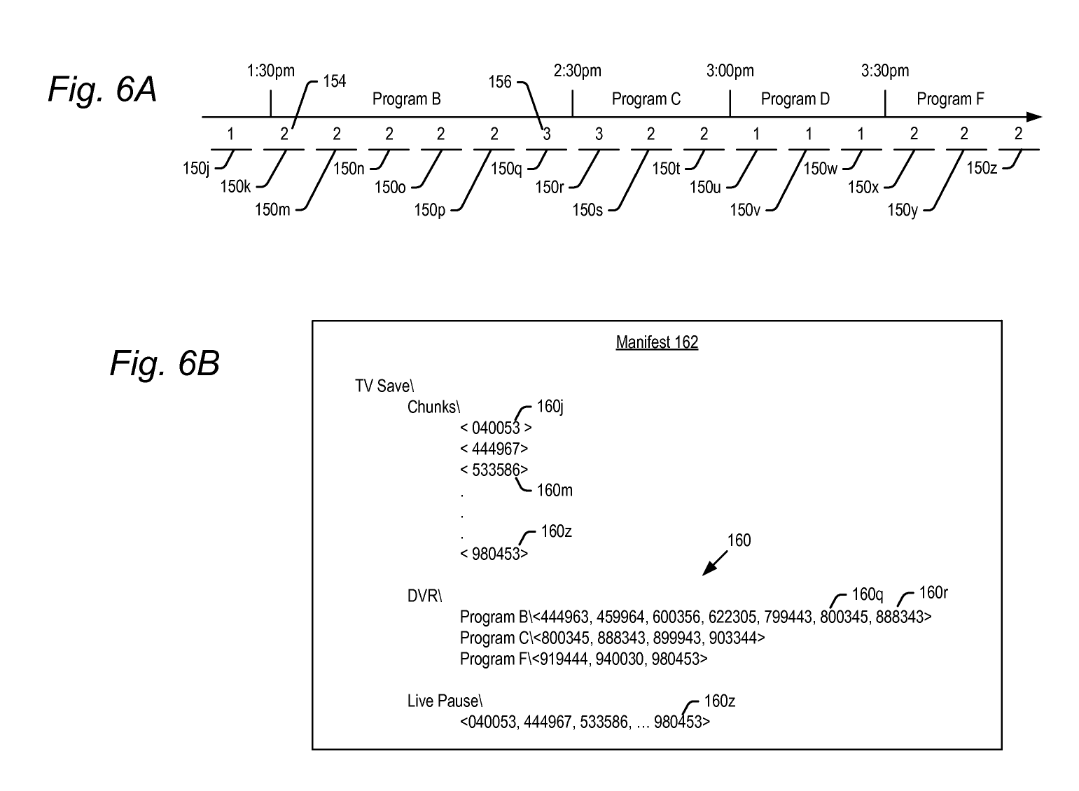

Each data chunk may be stored in its own file in memory 108, identified using some form of unique identifier. The identifier may for example be a GUID (globally unique identifier), which may be stored in step 208 in association with each data chunk. Other identifiers are possible. The chunk identifier may be stored in memory 108 for example in a look-up table, or manifest 162, as explained below with respect to FIGS. 6A and 6B.

Additionally, in accordance with further aspects of the present technology, a data value representing a reference count of a data chunk may also be generated and stored in step 208 in association with each data chunk. All data chunks of received and buffered data are automatically assigned a first reference count. In embodiments that follow, this first reference count may be a data value of ‘1’. However, it is understood that this first reference count may be set to other values in further embodiments. As explained below, the reference count of one or more stored data chunks may be changed when a user records the content stored in the one or more data chunks. The reference count of a data chunk may also be stored in memory 108 in step 208. In the above, description, the data chunks, identifier and reference count are all stored in memory 108. It is contemplated that one or more of these data items be stored in different storage locations in further embodiments.

In step 212, a chunking algorithm stored in memory 108 and executed by CPU 102 monitors the size of data within a data chunk. As noted, the chunking algorithm may alternatively monitor the length of time data is added to a data chunk. If the size of a data chunk has reached its predefined limit in step 212, a new data chunk is started and assigned an identifier and the first reference count in step 214. Accordingly, as the stream of content is received, it is continuously buffered in successive data chunks in memory 108, each data chunk having a unique identifier and an automatically-generated first reference count associated therewith in memory. The temporal order with which the data chunks are created is also known and stored in memory 108. At some point, older data chunks (that have not been designated for recording) are purged as explained below. Thus, new successive data chunks are continuously created and select old data chunks are continuously purged so that the buffer moves forward over time as content is received.

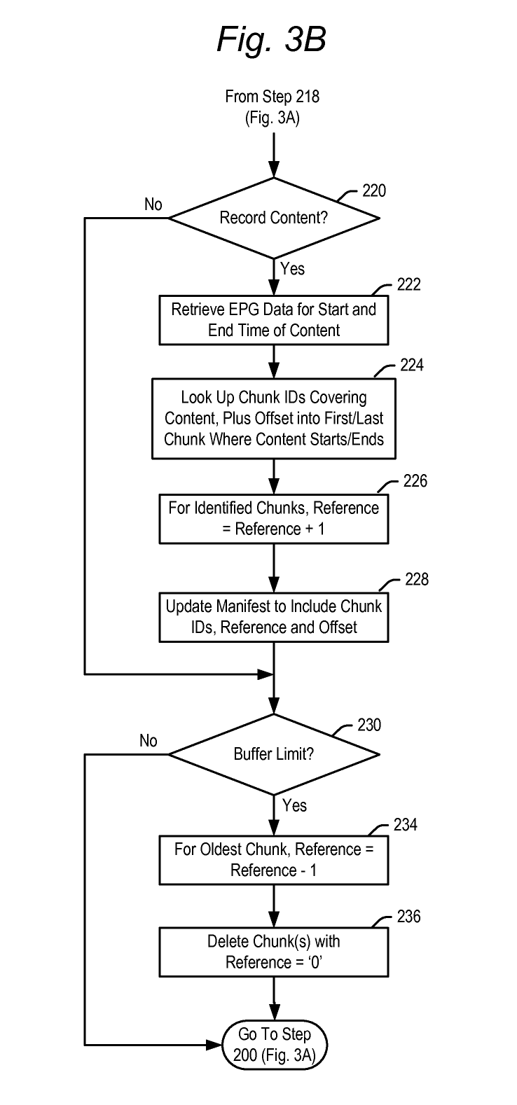

FIG. 4A illustrates a time line for an arbitrary time period on an arbitrary channel. During the time frame, content for programs A, B, C and D has been received within the computing device 110. As shown schematically, the content of programs A, B, C and D have been stored in discrete data chunks 150, and each buffered data chunk is automatically assigned a first reference count 152, for example having a value of ‘1’.

In step 216, the computing device 110 checks whether a live pause command has been received from the user, for example via remote control 144. If so, the display of the content may freeze, or rewind back through the data chunks, in step 218, depending on the received command. As noted, the temporal order in which data chunks are created is known and stored. Thus, a user may rewind backward seamlessly through the stored data chunks in reverse temporal order until the oldest remaining data chunk.

Upon rewinding to a given data chunk, the computing device 110 may display the content from that (and successive) data chunks at normal playback speed on the A/V device 116. The user may thereafter fast forward through the data chunks until the present frame of received and stored content. While executing a live pause command, content continues to come in and new data chunks are created.

Referring now to FIG. 3B, the chunking algorithm checks in step 220 whether a command to record selected content is received, for example via remote control 144. Instead of a manual recording, it could be an algorithm executing on the computing device 110 that decides what to record, based on stored user preferences. If so, the start and end time of the content to be recorded is determined (for example from the EPG data). In step 224, the stored data chunks 150 covering that time period are identified. It may be that an end time of the recorded content occurs in the future, so that one or more of the data chunks 150 will be created in the future, as the data for the recorded content comes into computing device 110.

It is unlikely, though possible, that the requested content will begin at the beginning of a first data chunk and end at the end of some later data chunk. Where the data chunks are sufficiently small, the recording may simply begin at the beginning of the first data chunk and end at the end of the later data chunk. However, the data chunks may be large enough that it is desirable to determine some offset into the first data chunk where the recorded content begins, and determine some offset into the last data chunk where the recorded content ends. This determination is also made in step 224. The time of content in each data chunk may be determined from a known start and end time during which the data chunk was stored. Alternatively, the time of content in each data chunk may be stored when the data chunk is created.

In step 226, the reference count of the data chunks covering the data to be recorded is updated to a second count. In embodiments that follow, this second reference count may be a data value of ‘2’. However, it is understood that this second reference count may be set to other values in further embodiments. In embodiments where the first and second reference counts are values of ‘1’ and ‘2’, respectively, step 226 may simply update the reference count by adding one. There can be at least a third reference count where the end of one recorded show overlaps with the beginning of another recorded show. In this instance, as explained below, the third reference count can be a value of ‘3’, and step 226 can still operate to update the reference count by adding one. However, it is understood that step 226 can update the affected data chunks in other ways where the first, second and/or third reference counts are indicated by values or flags other than ‘1’, ‘2’ and ‘3’.

Assigning different reference counts to the stored data chunks is significant in that it allows multiple different systems (i.e., the moving live pause buffer and one or more recorded DVR streams) to share and have access to a single copy of the data chunks. Thus, there is no need to duplicate the data between the respective systems. Moreover, such a system allows seamless transition between live pause and watching a channel on the one hand and recording the channel on the other hand.

It is a further feature that, given there is no duplication of data when living pausing and recording data, there is less input to and less output from memory 108. In step 228, the chunking algorithm may update the manifest to include the new reference counts for the indicated chunk identifiers, and to store any offsets in the beginning and ending data chunks.

FIG. 4B illustrates a time line for an arbitrary time period on an arbitrary channel as in FIG. 4A. During the time frame, content for programs A, B, C and D has been received within the computing device 110. In FIG. 4B, the computing device 110 has received an indication to record program B. As shown, the data chunks 150 associated with buffered (but unrecorded) programs A, C and D retain their first reference count 152, for example having a value of ‘1’. However, upon receiving an indication to record the program B, steps 222, 224, 226 and 228 were performed, and the reference counts of data chunks 150a-150f were updated to the second reference count 154, for example having a value of ‘2’.

As noted, old unrecorded data chunks are purged as the rolling buffer moves forward. In step 230 of FIG. 3B, the chunking algorithm checks whether the buffer has reached its limit and is full. As explained above, the buffer is storage space within memory 108, and may be a predefined size or length, such as for example two hours of streaming video. The buffer may be larger or smaller than this in further embodiments.

As data chunks are relatively small, discrete amounts of content data, it is a feature of the present technology that individual data chunks may be easily purged. When a buffer limit is reached in step 230, the oldest data chunk is examined and, if not recorded, the data chunk is purged or deleted. In particular, the oldest data chunk or number of oldest data chunks which have the first reference count (i.e. unrecorded) are updated to a reference count zero in step 234. This may for example be represented by a reference count equal to ‘0’, but it may be represented by other values in further embodiments. In embodiments where the first reference count is a ‘1’, the second reference count is a ‘2’, etc., step 234 may simply update the existing reference count by subtracting one. Thus, data chunks that previously had a reference count of ‘2’ are updated to ‘1’, and data chunks that previously had a reference count of ‘1’ are updated to ‘0’. When examining the oldest chunks, if their reference count is 1 or higher, the chunk is left intact, otherwise, it may be purged.

In step 236, any data chunks of reference count zero may be deleted, purged or recycled to free up space for new data chunks. FIGS. 4C and 4D illustrate time lines for arbitrary time periods on an arbitrary channel as in FIGS. 4A and 4B. In FIG. 4C, older data chunks (before 1:30 pm) that were not recorded (i.e., were in the first reference count) have been purged as the rolling buffer moves forward. FIG. 4D is a time line showing the same data chunks as in FIG. 4C, but at a later time period, for example the next day. All unrecorded data chunks adjacent the recorded data chunks have been purged. Program B, which was recorded as described above, is stored in data chunks that did not get deleted, as their reference count was other than the first reference count (e.g., greater than ‘1’) when they were examined for purging. Thus, the data chunks 150 for program B remain in memory 108 for later playback.

Referring again to the flowchart of FIG. 3B, if the buffer is not full in step 230, or it is full and one or more chunks have been deleted in step 236, the flow may return to step 200 to receive further content. The flow may then begin again.

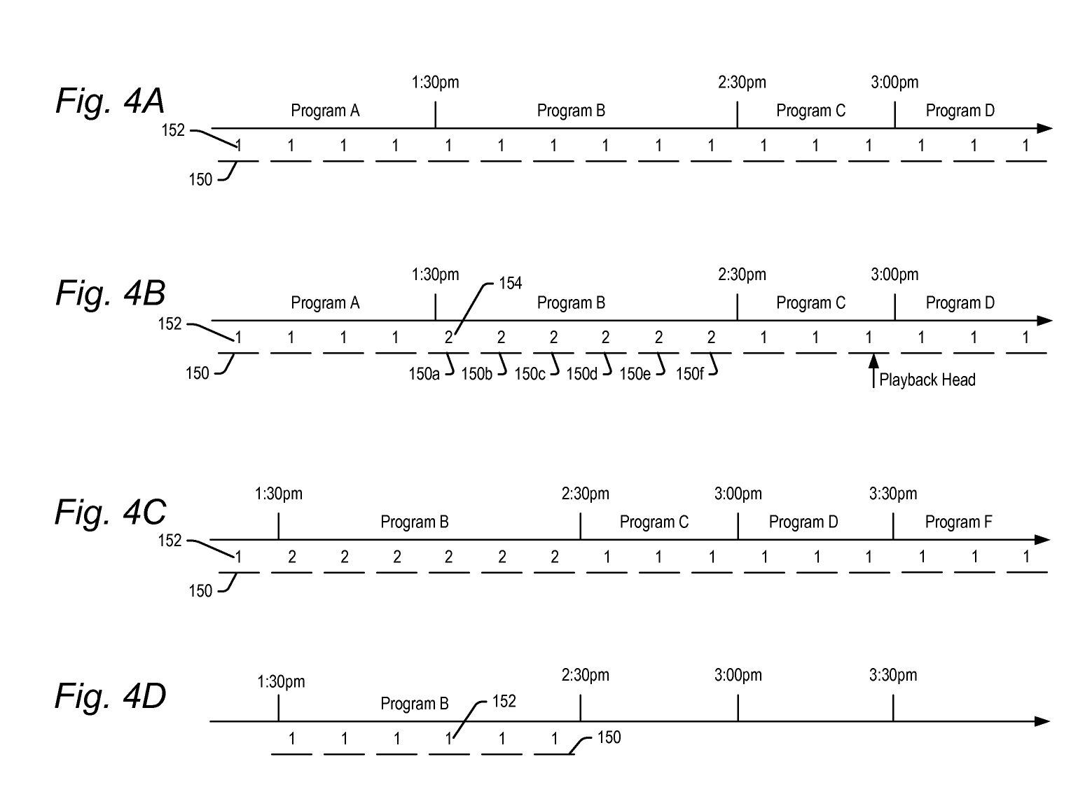

As noted above, it may happen that a user wishes to record back-to-back shows on the same channel. Those shows are on in succession and may be recorded without overlap. However, at times it is desirable to start recording a show a little before it starts, and stop recording a little after it ends to ensure that the entire program is captured. This may lead to a situation where one or more data chunks are used by more than one recording (i.e., the one or more data chunks at the end of the first recording and the beginning of the second recording). This is handled by the present technology as will now be explained to the flowchart of FIGS. 3A and 3B and the time lines of FIGS. 5A-5D.

In FIG. 5A, data has come into the computing device 110 for programs A, B, C and D, and has been buffered in data chunks 150. Each has been automatically assigned the first reference count, for example ‘1’, as described in step 208. At some point before the data chunks for program B have been purged, the computing device 110 received an indication to record program B. Thus, as shown in FIG. 5B the data chunks 150a-150f associated with program B have been updated to the second reference count, for example ‘2’. There was also an indication in this example to record a time period after the program B was supposed to end. The number of data chunks covering this additional recording time period may be determined and the reference counts for those one or more data chunks may also be updated to the second reference count. In this example, the additional recording time is contained within a single data chunk, 150g, and that data chunk is updated to reference count ‘2’ as well.

At some later point, before the data chunks for program C have been purged, the computing device 110 received an indication to record program C. Thus, as shown in FIG. 5C the data chunks 150h and 150i associated with program C have been updated to the second reference count. The first data chunk, 150g, had already been updated to reference count ‘2’ as it is being recorded as part of program B. Thus, as it is also being recorded as part of program C, it is updated to the third reference count 156, which may for example have a data value of ‘3’, but may have other values in further embodiments. The reference count for data chunk 150g may be updated to ‘3’ in step 226.

There was also an indication in this example to record a time period before the program C was supposed to start. Again, the number of data chunks covering this additional recording time period may be determined and the reference counts for those one or more data chunks may also be updated. In this example, the additional recording time is contained within a single data chunk, 150f. As this data chunk already had a reference count of ‘2’, it is updated to the reference count ‘3’ in step 226 as well.

FIG. 5D shows the data chunks 150a-150g at some later time period, after adjacent unrecorded data chunks have been purged in steps 230, 234 and 236. In step 234, the data chunks 150f and 150g have been updated from the third reference count to the second reference count as shown in FIG. 5D.

By noting with the reference counts which DVR recording streams have overlapping time periods, the data chunks for these respective recording streams may be shared without having to store multiple data streams. A single stream of recorded data chunks may be shared by multiple, possibly overlapping, recording streams.

It may also happen that a user manually deletes recorded content. In this event, the reference count associated with the data chunks to be deleted may be decremented, for example from reference count ‘1’ to reference count ‘0’. Moreover, if recorded content overlaps (e.g., overlapping data chunks have a reference count of ‘2’), then deleting either program will leave the correct chunks alive including those previously in the overlap, which now have a reference count of for example ‘1’. Deleting both overlapping programs deletes all chunks associated with the overlapping content.

FIG. 6B shows an example of a manifest 162 which may be generated from the data chunks 150j-150z shown in FIG. 6A. The manifest 162 may include a listing of unique identifiers 160 for all data chunks currently saved within the buffer. In this example, data chunks 150j-150z are indicated by GUIDs 160j-160z, respectively. Only some of the GUIDs are shown with reference numbers in FIG. 6Bm and it is understood that the particular GUIDs shown are by way of example only. Moreover, as noted, the identifier need not be a GUID. Other monotonically incrementing integers may be used instead of GUIDs in further examples. The manifest may also show which programs have been recorded to the DVR, and the GUIDs of the data chunks recorded for those programs. In this example, programs B, C and F have been recorded, and their associated data chunks have been updated to reference count ‘2’ in FIG. 6A. These programs are listed in manifest 162 together with the GUIDs for the data chunks containing the data for those programs.

Some of the data chunks (150q and 150r) are shared between the overlapping recording of programs B and C. The GUIDs for these data chunks are shown in manifest 162 as being part of both programs B and C. Lastly, the manifest may show the GUIDs for unrecorded data chunks in the live buffer (data chunks 150j, 150u, 150v, 150w in this example). The manifest 162 may be updated as data chunks are purged and new data chunks are added to the rolling buffer. It is understood that the organization of information in manifest 162 is by way of example only, and the data chunks, their identifiers and their reference counts may be indicated on other ways in further embodiments.

In the embodiments described above, programs may be recorded when viewing a buffering content from a particular channel. However, as indicated in steps 204 and 206 of FIG. 3A, it is possible that a user may be watching and buffering one channel, but may record content from another channel using the EPG for broadcast or IPTV. In such embodiments, data chunks may be buffered and/or recorded as described above, and their reference counts set as described above. Additionally, when it comes time to record the content from another channel, a second independent stream of data chunks may be recorded for the second channel.

In particular, the recorded data for the second channel may also be divided into data chunks as described above, and reference counts for those data chunks set to the second reference count (and run through the purging steps described above), or set to the first reference count (and not run through the purging steps describe above). The data chunks for the recorded content on the second channel may then be saved to memory, together with the data chunks for the buffered and/or recorded content on the channel being watched.

In embodiments, only the channel to which the computing device is tuned is buffered. However, it is conceivable that more than one channel be buffered in further embodiments. In such embodiments, each channel may generate independent streams of moving buffers of data chunks 150. Each such stream of data chunks may operate as described above, having reference counts assigned to data chunks to indicate which systems are making use of the data chunks.

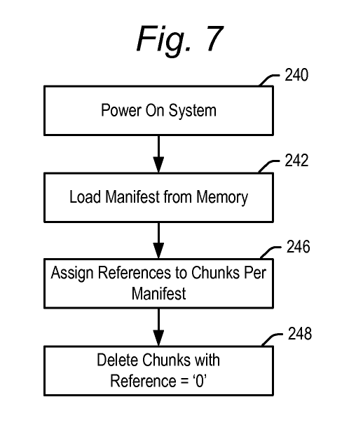

It may happen that the computing device has power loss, and needs to be restarted. FIG. 7 shows a flowchart of the operation of the present technology in this event. In step 240, the computing device may be powered on. In step 242, the manifest 162 may be loaded from non-volatile memory 108. In step 246, reference counts for any chunks may be updated per their current count as indicated by the manifest. And in step 248, any data chunks which have a reference count of ‘0’ (or were updated to have a reference count of ‘0’ in step 246) may be purged.

In embodiments described above, the present technology uses reference counting to enable one or more ‘systems’ keep each chunk ‘alive’, where a ‘system’ is the live pause system and/or any number of recording streams and/or any number of reading streams. However, it is understood that schemes other than reference counting may be used to enable multiple systems to keep chunks alive. As one such example, additional ‘hard links’ could be provided in the file system which keep each chunk alive and each system has its own ‘hard link’. This is analogous to reference counting but it moves the reference counting into and out of the code as written into the file system.

Moreover, in embodiments described above, programs may be recorded from start to finish (with some additional time at the beginning or end of the program). However, users may also use the current technology for custom recording, where a recording may not line up to a whole program, or they may straddle multiple programs. For example, using the remote control 144, a user may enter a command to record program x at 10:17 am for 5 minutes. Such a recording would be performed as described above. It is possible with such custom recording that a chunk may have 3, 4, 5 or even more references (e.g., reference count=3, 4 or 5 or more) with multiple overlapping custom recordings.

As explained above, recorded content is not stored as a single, copyable, file in the present technology. However, it is conceivable that recorded content may be stored as a single, copyable file and stored elsewhere. For example, an ‘export’ functionality may be implemented, which can stitch chunks together and save them on for example an external drive or in the cloud.

FIG. 8 illustrates an example embodiment of a computing system that may be used to implement the computing device 110. As shown in FIG. 8, the multimedia console 500 has a central processing unit (CPU) 501 having a level 1 cache 502, a level 2 cache 504, and a flash ROM 506 that is non-volatile storage. The level 1 cache 502 and a level 2 cache 504 temporarily store data and hence reduce the number of memory access cycles, thereby improving processing speed and throughput. CPU 501 may be provided having more than one core, and thus, additional level 1 and level 2 caches 502 and 504. The flash ROM 506 may store executable code that is loaded during an initial phase of a boot process when the multimedia console 500 is powered on.

A graphics processing unit (GPU) 508 and a video encoder/video codec (coder/decoder) 514 form a video processing pipeline for high speed and high resolution graphics processing. Data is carried from the graphics processing unit 508 to the video encoder/video codec 514 via a bus. The video processing pipeline outputs data to an A/V (audio/video) port 540 for transmission to a television or other display. A memory controller 510 is connected to the GPU 508 to facilitate processor access to various types of memory 512, such as, but not limited to, a RAM.

The multimedia console 500 includes an I/O controller 520, a system management controller 522, an audio processing unit 523, a network (or communication) interface 524, a first USB host controller 526, a second USB controller 528 and a front panel I/O subassembly 530 that are preferably implemented on a module 518. The USB controllers 526 and 528 serve as hosts for peripheral controllers 542(1)-542(2), a wireless adapter 548 (another example of a communication interface), and an external memory device 546 (e.g., flash memory, external CD/DVD ROM drive, removable media, etc. any of which may be non-volatile storage). The network interface 524 and/or wireless adapter 548 provide access to a network (e.g., the Internet, home network, etc.) and may be any of a wide variety of various wired or wireless adapter components including an Ethernet card, a modem, a Bluetooth module, a cable modem, and the like.

System memory 543 is provided to store application data that is loaded during the boot process. A media drive 544 is provided and may comprise a DVD/CD drive, Blu-Ray drive, hard disk drive, or other removable media drive, etc. (any of which may be non-volatile storage). The media drive 544 may be internal or external to the multimedia console 500. Application data may be accessed via the media drive 544 for execution, playback, etc. by the multimedia console 500. The media drive 544 is connected to the I/O controller 520 via a bus, such as a Serial ATA bus or other high speed connection (e.g., IEEE 1394).

The media console 500 may include a variety of computer readable media. Computer readable media can be any available tangible media that can be accessed by computer 441 and includes both volatile and nonvolatile media, removable and non-removable media. Computer readable media does not include transitory, transmitted or other modulated data signals that are not contained in a tangible media.

The system management controller 522 provides a variety of service functions related to assuring availability of the multimedia console 500. The audio processing unit 523 and an audio codec 532 form a corresponding audio processing pipeline with high fidelity and stereo processing. Audio data is carried between the audio processing unit 523 and the audio codec 532 via a communication link. The audio processing pipeline outputs data to the A/V port 540 for reproduction by an external audio user or device having audio capabilities.

The front panel I/O subassembly 530 supports the functionality of the power button 550 and the eject button 552, as well as any LEDs (light emitting diodes) or other indicators exposed on the outer surface of the multimedia console 500. A system power supply module 536 provides power to the components of the multimedia console 500. A fan 538 cools the circuitry within the multimedia console 500.

The CPU 501, GPU 508, memory controller 510, and various other components within the multimedia console 500 are interconnected via one or more buses, including serial and parallel buses, a memory bus, a peripheral bus, and a processor or local bus using any of a variety of bus architectures. By way of example, such architectures can include a Peripheral Component Interconnects (PCI) bus, PCI-Express bus, etc.

When the multimedia console 500 is powered on, application data may be loaded from the system memory 543 into memory 512 and/or caches 502, 504 and executed on the CPU 501. The application may present a graphical user interface that provides a consistent user experience when navigating to different media types available on the multimedia console 500. In operation, applications and/or other media contained within the media drive 544 may be launched or played from the media drive 544 to provide additional functionalities to the multimedia console 500.

The multimedia console 500 may be operated as a standalone system by simply connecting the system to a television or other display. In this standalone mode, the multimedia console 500 allows one or more users to interact with the system, watch movies, or listen to music. However, with the integration of broadband connectivity made available through the network interface 524 or the wireless adapter 548, the multimedia console 500 may further be operated as a participant in a larger network community. Additionally, multimedia console 500 can communicate with processing unit 4 via wireless adaptor 548.

When the multimedia console 500 is powered ON, a set amount of hardware resources are reserved for system use by the multimedia console operating system. These resources may include a reservation of memory, CPU and GPU cycle, networking bandwidth, etc. Because these resources are reserved at system boot time, the reserved resources do not exist from the application's view. In particular, the memory reservation preferably is large enough to contain the launch kernel, concurrent system applications and drivers. The CPU reservation is preferably constant such that if the reserved CPU usage is not used by the system applications, an idle thread will consume any unused cycles.

With regard to the GPU reservation, lightweight messages generated by the system applications (e.g., pop ups) are displayed by using a GPU interrupt to schedule code to render popup into an overlay. The amount of memory used for an overlay depends on the overlay area size and the overlay preferably scales with screen resolution. Where a full user interface is used by the concurrent system application, it is preferable to use a resolution independent of application resolution. A scaler may be used to set this resolution such that the need to change frequency and cause a TV resync is eliminated.

After multimedia console 500 boots and system resources are reserved, concurrent system applications execute to provide system functionalities. The system functionalities are encapsulated in a set of system applications that execute within the reserved system resources described above. The operating system kernel identifies threads that are system application threads versus gaming application threads. The system applications are preferably scheduled to run on the CPU 501 at predetermined times and intervals in order to provide a consistent system resource view to the application. The scheduling is to minimize cache disruption for the gaming application running on the console.

When a concurrent system application uses audio, audio processing is scheduled asynchronously to the gaming application due to time sensitivity. A multimedia console application manager (described below) controls the gaming application audio level (e.g., mute, attenuate) when system applications are active.

Optional input devices (e.g., controllers 542(1) and 542(2)) are shared by gaming applications and system applications. The input devices are not reserved resources, but are to be switched between system applications and the gaming application such that each will have a focus of the device. The application manager preferably controls the switching of input stream, without knowing the gaming application's knowledge and a driver maintains state information regarding focus switches. Capture device 320 may define additional input devices for the console 500 via USB controller 526 or other interface. In other embodiments, computing system 312 can be implemented using other hardware architectures. No one hardware architecture is required.

In summary, embodiments of the present technology relate to a method of implementing live pausing and recording of a stream of content received within a computing system, comprising: (a) dividing up the stream of content into a plurality of data chunks; (b) assigning a first reference count to data chunks which have not been designated for recording; (c) assigning a second reference count to data chunks which have been designated for recording; and (d) maintaining a live pause buffer of predetermined length, the live pause buffer moving forward over time by creating new data chunks as new portions of the stream of content are received, and by purging old data chunks having the first reference count.

In another example, the present technology relates to a system for implementing live pausing and recording of a stream of content, comprising: a processor configured to receive the stream of data and dividing it into a plurality of data chunks, the processor further configured to automatically assign a first reference count to the plurality of data chunks indicating the data chunks are used for live pausing, the processor receiving an indication to record a portion of the data stream, the processor updating the first reference count to a second reference count for data chunks having the portion of the data stream to be recorded, the processor purging data chunks having the first reference count after a predetermined period of time, and the processor not purging data chunks having the second reference count after expiration of the predetermined period of time; and a memory storage for saving the data chunks having the second reference count that are not purged after expiration of the predetermined period of time.

In a further example, the present technology relates to a computer-readable media for programming a processor to perform a method of implementing live pausing and recording of a stream of content, comprising: (a) dividing the stream of the content into a plurality of discrete data chunks; (b) assigning a reference count the plurality of discrete data chunks indicating which chunks of the plurality of data chunks are used in the live pausing of the stream of content, and which data chunks are used in the recording of the stream of content; and (c) sharing data chunks of the plurality of data chunks between both the live pausing of the stream of content and the recording of the stream of content based on the reference counts of the data chunks.

In a further example, the present technology relates to a means for receiving a stream of data and dividing it into a plurality of data chunks, means for automatically assigning a first reference count to the plurality of data chunks indicating the data chunks are used for live pausing, means for receiving an indication to record a portion of the data stream, means for updating the first reference count to a second reference count for data chunks having the portion of the data stream to be recorded, means for purging data chunks having the first reference count after a predetermined period of time, and not purging data chunks having the second reference count after expiration of the predetermined period of time; and means for saving the data chunks having the second reference count that are not purged after expiration of the predetermined period of time.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. It is intended that the scope of the invention be defined by the claims appended hereto.

We claim:

1. A method of implementing live pausing and recording of a stream of content received within a computing system, comprising:
(a) dividing up the stream of content into a plurality of data chunks;
(b) assigning a first reference count to data chunks which have not been designated for recording;
(c) assigning a second reference count to data chunks which have been designated for recording; and
(d) maintaining a live pause buffer, the live pause buffer moving forward over time by creating new data chunks as new portions of the stream of content are received, and by purging old data chunks having the first reference count.

2. The method of claim 1, the method further comprising the step of maintaining the data chunks assigned the second reference count when the data chunks assigned the second reference count are outside of the live pause buffer.

3. The method of claim 1, further comprising the step of sharing data chunks between both the live pausing and the recording of the stream of content without duplicating data chunks.

4. The method of claim 1, wherein said step (a) comprises the step of dividing the stream of the content into a plurality of discrete data chunks of a predefined size.

5. The method of claim 1, wherein said step (a) comprises the step of dividing the stream of the content into a plurality of discrete data chunks captured over a predefined length of time.

6. The method of claim 1, further comprising the step of recording at least portions of two programs in the stream of content having overlapping end and start times without duplicating data chunks used in the overlap period.

7. The method of claim 6, further comprising the step of assigning data chunks in the stream of content having overlapping end and start times a third reference count.

8. The method of claim 7, the method further comprising the step of maintaining the data chunks having the third reference count when the data chunks having the third reference count are outside of the live pause buffer.

9. A system for implementing live pausing and recording of a stream of content, comprising:
a processor configured to receive the stream of data and dividing it into a plurality of data chunks, the processor further configured to automatically assign a first reference count to the plurality of data chunks indicating the data chunks are used for live pausing, the processor receiving an indication to record a portion of the data stream, the processor updating the first reference count to a second reference count for data chunks having the portion of the data stream to be recorded, the processor purging data chunks having the first reference count after a predetermined period of time, and the processor not purging data chunks having the second reference count after expiration of the predetermined period of time; and
a memory storage for saving the data chunks having the second reference count that are not purged after expiration of the predetermined period of time.

10. The system of claim 9, the memory storage further saving the data chunks having the first reference count, the processor deleting from the memory the data chunks having the first reference count upon expiration of the predetermined period of time.

11. The system of claim 9, the processor sharing data chunks between both the live pausing of the stream of content and the recording of the stream of content based on the reference counts of the data chunks.

12. The system of claim 9, the processor sharing data chunks between both the live pausing of the stream of content and the recording of the stream of content, without duplication of data chunks, based on the reference counts of the data chunks.

13. The system of claim 9, the portion of the data stream to be recorded comprises a first portion to be recorded in a first recording and a second portion to be recorded in a second recording, the first and second portions having an overlapping portion comprising data chunks common to both the first and second recordings, the sharing the data chunks common to the first and second recordings without duplicating the data chunks common to the first and second recordings.

14. The system of claim 13, the processor further updating the reference count for the data chunks common to the first and second recordings from the second reference count to a third reference count.

15. The system of claim 9, the processor dividing the stream of content into a plurality of data chunks each having one of a predefined size or including a predefined length of time of data from the stream of content.

16. A computer-readable media for programming a processor to perform a method of implementing live pausing and recording of a stream of content, comprising:
(a) dividing the stream of the content into a plurality of discrete data chunks;
(b) assigning a reference count the plurality of discrete data chunks indicating which chunks of the plurality of data chunks are used in the live pausing of the stream of content, and which data chunks are used in the recording of the stream of content; and
(c) sharing data chunks of the plurality of data chunks between both the live pausing of the stream of content and the recording of the stream of content based on the reference counts of the data chunks.

17. The computer-readable media of claim 16, further comprising the step of purging, after a period of time, data chunks used for live pausing of the stream of content and not used for recording of the stream of content.

18. The method of claim 17, further comprising the step of saving, after expiration of the period of time, data chunks used for recording of the stream of content.

19. The method of claim 16, wherein said step (b) of assigning a reference count to the plurality of discrete data chunks comprises the steps of
assigning a first reference count to data chunks used for the live pausing of the stream of content;
assigning a second reference count to data chunks including content data to be recorded;
discarding data chunks having the first reference count after a period of time; and
not discarding data chunks having the second reference count after expiration of the period of time.

20. The method of claim 19, further comprising the step of assigning a third reference count to data chunks included within an overlapping portion of two separate recordings, and saving data chunks having the third reference count after expiration of the period of time.
